(19) United States
(12) Patent Application Publication
(10) Pub. No.: US 2026/0313319 A1
(43) Pub. Date: Oct. 8, 2026

(54) DYNAMIC ANTENNA TUNING FOR BROADCASTS BASED ON ADVERTISEMENT PACKET FEEDBACK

(71) Applicant: GOOGLE LLC, Mountain View, CA (US)

(72) Inventors: Qi Jiang, San Jose, CA (US); Li-Xuan Chuo, San Jose, CA (US); Praveen Kumar Rayasamudra Vijayakumar, Sunnyvale, CA (US)

(21) Appl. No.: 19/098,593

(22) Filed: Apr. 2, 2025

(51) Int. Cl. H04W 4/06; H04B 7/06

(52) U.S. Cl. CPC H04W 4/06; H04B 7/0617

(57) ABSTRACT

The antennas of a user equipment (UE) broadcast packets of an audio stream on isochronous channels in one or more directions based on an antenna tuning profile. Concurrently with broadcasting these packets, the UE listens for advertisement packets each indicating corresponding link quality data from a receiver device subscribed to the audio stream and the UE determines the angles of arrival at which the advertisement packets were received. Using the link quality data and angles of arrival of the advertisement packets, the UE determines beamform weights that indicate a desired beamform pattern for the antennas of the UE. The UE then updates the antenna tuning profile based on the beamform weights and the antennas of the UE broadcast additional packets of the audio stream in directions as indicated by the updated antenna tuning profile.

### BACKGROUND

Some user equipment (UE) is configured to concurrently provide an audio stream to two or more receiver devices, such as earbuds, headphones, speakers, and the like, by broadcasting packets of the audio stream on one or more isochronous channels. The UE broadcasts the packets of the audio stream using a predetermined antenna tuning that indicates the directions in which the UE is to broadcast the packets. After being broadcast by the UE, the packets of the audio stream are receivable by any number of receiver devices within the broadcast range. However, because the packets of the audio stream are broadcast rather than sent over an established connection, the UE is unable to receive data from the receiver devices subscribed to the broadcast and cannot modify the antenna tuning of the UE. As such, the UE is unable to change the directions in which it broadcasts the packets of the audio signals and cannot improve the quality of the broadcast for certain receiver devices subscribed to the broadcast.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a user equipment (UE) broadcast framework configured to adjust an antenna tuning profile based on advertisement packets from one or more receiver devices, in accordance with some embodiments.

FIG. 2 is a flow diagram of an example operation for modifying an antenna tuning profile based on link quality data and angles of arrivals associated with receiver devices, in accordance with some embodiments.

FIG. 3 is a flow diagram of an example method for adjusting an antenna tuning profile for a broadcast based on advertisement packets from one or more receiver devices, in accordance with some embodiments.

### DETAILED DESCRIPTION

Systems and techniques disclosed herein include user equipment (UE), such as compute-enabled phones (i.e., smartphones), tablet computers, personal computers, compute-enabled wearable devices, Internet of Things (IoT) devices, laptop computer, routers, mobile hotspot devices, automotive devices, manufacturing devices, and the like, configured to broadcast an audio stream such that multiple receiver devices within the range of the broadcast receive the audio stream. The UE uses one or more isochronous channels to broadcast packets of the audio stream based on one or more certain communication protocols, for example, Bluetooth® Low Energy communication protocol (Bluetooth LE), so that the packets of the audio stream are receivable within a certain range (e.g., the distance from the UE at which packets broadcast by the UE are receivable by a receiver device). Further, the UE includes one or more antennas that broadcast the packets of the audio stream in one or more directions according to an antenna tuning profile. This antenna tuning profile, for example, indicates which antennas are to broadcast packets of the audio stream, corresponding directions for one or more antennas of the UE at which to broadcast packets, or both. As an example, an antenna tuning profile indicates corresponding phases, amplitudes, or both for one or more antennas of the UE at which to broadcast packets of the audio stream so as to achieve desired beamforming, coverage, or both for the broadcast packets.

In response to receiving one or more packets of the audio stream broadcast by the UE, a receiver device is configured to output the audio in the received packets. Such receiver devices, for example, include portable devices having one or more output devices (e.g., speakers) such as wireless headphones, wireless earbuds, wireless in-ear monitors, wireless over-ear headphones, wireless on-ear headphones, bone-conduction headphones, wireless speakers, wireless hearing aids, and the like. Further, in response to receiving one or more packets of the broadcast audio stream, a receiver device is configured to begin periodically broadcasting (e.g., every second) an advertisement packet indicating link status data associated with the received audio stream. Such link status data includes, for example, how choppy the received audio stream is for a corresponding receiver device, a packet error rate (PER) for a corresponding receiver device, the number of times a corresponding receiver device was out of sync with the broadcast audio stream, or any combination thereof, to name a few. Additionally, in response to broadcasting one or more packets of the audio stream, the UE is configured to periodically listen for advertisement signals broadcast by any receiver device. From these received advertisement signals, the UE identifies the receiver devices that are actively receiving the broadcast audio stream (e.g., subscribed to the audio stream). For example, in response to detecting an advertisement packet indicating that the advertisement signal includes link status data, the UE determines that the receiver device identified in the advertisement packet is actively receiving the broadcast audio stream and adds data representing the receiver device to a list of receiver devices current receiving subscribed to the audio stream (e.g., a broadcast subscriber list).

For each receiver device identified in this list (e.g., for each subscribed receiver device), the UE determines the angle of arrival (AoA) at which one or more advertisement packets from the subscriber receiver device were received. Further, the UE determines broadcast subscriber data representing the quality of the link between the UE and the subscribed receiver device based on link status data indicated in one or more advertisement packets from the subscribed receiver device. As an example, the UE determines broadcast subscriber link data indicating a PER, received signal strength indicator (RSSIs), or both. The UE then provides one or more determined AoAs and broadcast subscriber link data of each subscribed receiver device to a beamforming model implemented by the UE. This beamforming model, for example, includes a machine-learning model trained to generate one or more beamforming weights for one or more antennas of the UE in response to receiving one or more AoAs and broadcast subscriber link data of each subscribed receiver device as inputs. As an example, the beamforming model generates one or more beamforming weights for one or more antennas of the UE based on the AoA and broadcast subscriber link data (e.g., PER, RSSI) determined from the most recently received advertisement packet from each subscribed receiver device. These beamforming weights generated by the beamforming model, for example, indicate one or more respective directions at which corresponding antennas of the UE are to broadcast packets of the audio stream such that the UE broadcasts the packets in the directions of one or more subscribed receiver devices and improves the link quality between one or more subscriber receiver devices and the UE. That is to say, the beamforming model generates one or more beamforming weights for one or more antennas of the UE that achieve a beamforming pattern that improves the link quality between the UE and one or more of the subscribed receiver devices.

The beamforming model, for example, includes one or more trained supervised models, unsupervised models, reinforcement models, neural networks (recurrent neural networks, convolutional neural networks), large language models, multimedia large language models, natural language models, deep-learning models, federated learning models, or any combination thereof configured to receive one or more AoAs and link quality data of the subscribed receiver devices as inputs and provide one or more beamforming weights for corresponding antennas as an output according to a set of training data. Such training data, for example, includes data that modifies one or more parameters of the beamforming model so as to dictate the behavior of the beamforming model. As an example, the training data includes sets of correlated data (e.g., sets of correlated beamforming weights, AoAs, certain subscriber link data, or a combination thereof), reward functions, sets of labeled data, sets of unlabeled data, validation data, or any combination thereof.

After the beamforming model generates beamforming weights from the AoAs and broadcast subscriber link data of the subscribed receiver devices, the UE updates the antenna tuning profile based on the generated beamforming weights. For example, the UE updates the antenna tuning profile such that one or more antennas of the UE broadcast packets of the audio stream in one or more directions as indicated by one or more corresponding beamforming weights. The UE then broadcasts at least one additional packet of the audio stream based on the updated antenna tuning profile (e.g., the UE broadcasts the additional packets in one or more directions as indicated by the updated antenna tuning profile). In this way, the UE is configured to adjust the directions at which the UE broadcasts packets of the audio stream based on the link qualities between the UE and the subscribed receiver devices and the position of the subscribed receiver devices relative to the UE (e.g., as indicated by corresponding AoAs). That is to say, because the receiver devices are configured to begin broadcasting an advertisement signal including link status data in response to receiving the audio stream, the UE is enabled to receive data indicating the broadcast subscriber link data and AoAs of the receiver devices even though there is no direct connection between the UE and receiver devices. Further, due to the UE being enabled to determine this broadcast subscriber link data and AoAs for the receiver devices, the UE is able to broadcast packets of the audio stream in the directions of the subscribed receiver devices which helps improve the reception of the broadcast audio stream by the subscriber receiver devices.

As used herein, the term “circuitry” includes hardwired circuitry, programmable circuitry, or a combination thereof. For example, circuitry may include circuitry of an application-specific integrated circuit (ASIC) that is hardwired or hardcoded to perform corresponding functions, one or more processors that execute software stored in one or more memories or other storage media to perform corresponding functions, programmable logic that has been programmed to perform corresponding functions, or some combination thereof.

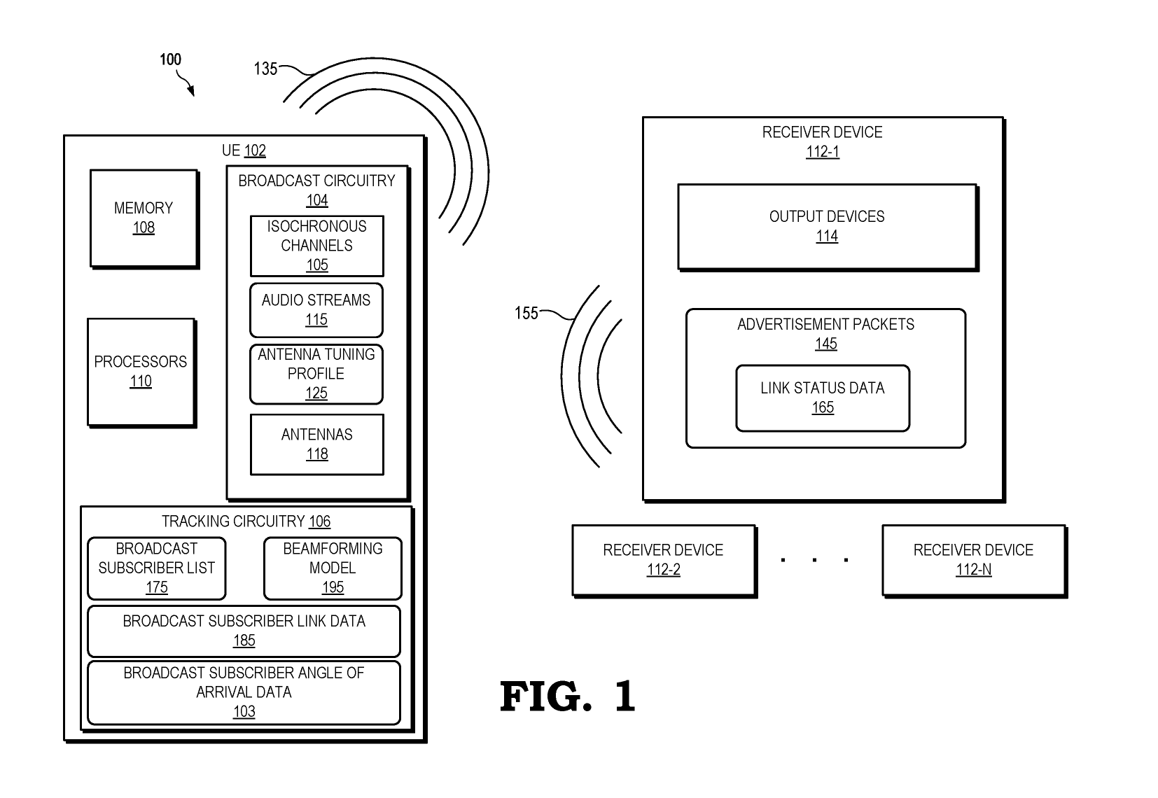

Referring now to FIG. 1, a block diagram of a UE broadcast framework 100 configured to adjust an antenna tuning profile based on advertisement packets from one or more receiver devices is presented, in accordance with some embodiments. In embodiments, UE broadcast framework 100 includes UE 102 configured to broadcast an audio stream 115 such that one or more packets of the broadcast audio stream (represented in FIG. 1 as broadcast audio stream 135) are received by one or more receiver devices 112 within the range of the broadcast (e.g., the distance from UE in which one or more packets of the broadcast audio stream 135 are receivable). UE 102, for example, includes a smartphone, tablet computer, personal computer, laptop computer, compute-enabled wearable device (e.g., smartwatch, fitness tracker, smart bracelet), IoT device, router, mobile hotspot device, an automotive device, a manufacturing device, or any combination thereof, to name a few. Additionally, an audio stream 115 includes one or more packets that include data representing audio to be output by one or more receiver devices 112.

To broadcast an audio stream 115, UE 102 includes broadcast circuitry 104 configured to broadcast one or more packets of the audio stream 115 using one or more isochronous channels 105 (e.g., broadcast isochronous channels). As an example, broadcast circuitry 104 includes one or more isochronous channels 105 over which broadcast circuitry 104 broadcasts packets of an audio stream 115 based on one or more communication protocols (e.g., a Bluetooth low energy communication protocol). An isochronous channel 105 is configured to broadcast one or packets of an audio stream 115 using a corresponding range of frequencies (e.g., 2MHz range of frequencies) such that the broadcast packets are receivable by receiver devices 112 within the range of the broadcast. Further, UE 102 includes one or more antennas 118 (e.g., an antenna array) that broadcast packets of the audio stream 115 in one or more directions for corresponding isochronous channels 105. As an example, UE 102 uses antennas 118 to broadcast packets of the audio stream 115 in one or more directions (e.g., directions from the UE 102) according to an antenna tuning profile 125 indicating one or more directions at which corresponding antennas 118 are to broadcast packets of the audio stream 115. As an example, antenna tuning profile 125 indicates one or more phases, amplitudes, or both at which one or more corresponding antennas 118 of UE 102 are to broadcast packets of the audio stream 115 so as to achieve desired beamforming, coverage, or both for the broadcast packets. According to some embodiments, antenna tuning profile 125 is an initial antenna tuning profile that indicates one or more predetermined directions in which one or more corresponding antennas 118 are to broadcast packets of the audio stream 115.

In embodiments, a receiver device 112 configured to receive a broadcast audio stream 115 includes, for example, a portable device configured to receive packets of a broadcast audio stream 135 using one or more communication protocols (e.g., Bluetooth LE) and to output audio represented by the received packets. For example, a receiver device 112 includes one or more wireless headphones, wireless earbuds, wireless in-ear monitors, wireless over-ear headphones, wireless on-ear headphones, bone-conduction headphones, wireless speakers, wireless hearing aids, and the like. In some embodiments, a receiver device 112 includes a paired device (e.g., one device of a pair of devices), such as one earbud of a pair of earbuds, while in other embodiments, a receiver device includes a singular device such as headphones. In response to receiving one or more packets of a broadcast audio stream 135, a receiver device 112 is configured to output the audio represented by the received packets using one or output devices 114 that include, for example, speakers, audio monitors, or the like. Though the example embodiment presented in FIG. 1 shows three receiver devices (112-1, 112-2, 112-N) representing an N integer number (where N>0) of receiver devices as receiving at least a portion of broadcast audio stream 135 (e.g., being within the broadcast range of UE 102), in other embodiments, any non-zero integer number of receiver devices receiving at least a portion of broadcast audio stream 135.

According to embodiments, one more receiver devices 112 are configured to periodically (e.g., every 500 milliseconds, every one second) broadcast one or more advertisement packets 145 including link status data 165 in response to receiving one or more packets of broadcast audio stream 135. This link status data 165 indicates the strength of the link between the receiver device 112 and UE 102 (e.g., the UE 102 that broadcast the audio stream 115). That is to say, the link status data 165 indicates how well the receiver device 112 is receiving packets of the broadcast audio stream 135. For example, link status data 165 includes a PER for the receiver device 112 over a predetermined period of time (e.g., the period of time between broadcasts of advertisement packets 145), the number of times the receiver device 112 was out of sync with the broadcast audio stream 135 over a predetermined period of time, or any combination thereof, to name a few. Further, an advertisement packet 145 broadcast by a receiver device 112 in response to receiving a packet of audio stream 115 includes data indicating that the receiver device 112 is subscribed to the broadcast of the audio stream 115 (e.g., an identifier indicating that the advertisement packet 145 includes link status data 165) an identifier of the receiver device 112 (e.g., a broadcast ID of the receiver device 112), link status data 165 over a predetermined period of time (e.g., one second), or any combination thereof. An advertisement packet 145 broadcast by a receiver device is represented in FIG. 1 as a broadcast advertisement packet 155.

After broadcasting one or more packets of audio stream 115, tracking circuitry 106 of UE 102 periodically listens for advertisement packets 145 broadcast by one or more receiver devices 112 (e.g., listens for broadcast advertisement packets 155). For example, UE 102 listens for broadcast advertisement packets 155 each time a predetermined period of time (e.g., one second) elapses. In response to detecting a broadcast advertisement packet 155, tracking circuitry 106 determines the receiver device 112 associated with the broadcast advertisement packet 155. As an example, tracking circuitry 106 identifies the receiver device 112 based on the identifier for the receiver device 112 (e.g., broadcast ID) indicated in the broadcast advertisement packet 155. After identifying the receiver device 112 associated with the detected broadcast advertisement packet 155, tracking circuitry 106 adds data identifying the receiver device 112 (e.g., a broadcast ID of the receiver device 112) to a broadcast subscriber list 175. This broadcast subscriber list 175, for example, includes data identifying the receiver devices 112 that are currently subscribed to (e.g., receiving one or more packets of) the broadcast audio stream 135. Additionally, in response to detecting a broadcast advertisement packet 155, tracking circuitry 106 is configured to generate broadcast subscriber AoA data 103 for the receiver device 112 identified in the broadcast advertisement packet 155 that represents the AoA at which the broadcast advertisement packet 155 was received by the UE 102. Further, for one or more receiver devices 112 identified in the broadcast subscriber list 175 (e.g., for one or more subscribed receiver devices 112), tracking circuitry 106 is configured to generate broadcast subscriber link data 185 based on the link status data 165, transmit power, or both indicated in the received broadcast advertisement packets 155 associated with a corresponding subscribed receiver device 112. This broadcast subscriber link data 185 includes data representing the quality of the link between the UE 102 and a corresponding subscribed receiver device 112 such as one or more PERs, RSSIs, normalized link quality values, or any combination thereof, to name a few.

Using the broadcast subscriber link data 185 and broadcast subscriber AoA data 103 determined for one or more of the subscribed receiver devices 112, UE 102 is configured to update the antenna tuning profile 125 such that UE 102 broadcasts packets of the audio stream 115 in the directions of the subscribed receiver devices 112. For example, tracking circuitry 106 is configured to implement a beamforming model 195 configured to generate one or more beamforming weights in response to receiving broadcast subscriber link data (e.g., one or more PERs, RSSIs, or both) and broadcast subscriber AoA data 103 of the subscribed receiver devices 112. As an example, beamforming model 195 is configured to provide one or more beamforming weights as an output in response to receiving the PER, RSSI, and AOA of each subscribed receiver device 112 as indicated by the most recently received broadcast advertisement packets 155 from the subscribed receiver devices 112. These beamforming weights generated by beamforming model 195 include, for example, one or more directions at which corresponding antennas 118 of the UE are to broadcast packets of the audio stream 115 such that the packets are broadcast in the directions of subscribed receiver devices 112. That is to say, the beamforming weights indicate one or more amplitudes, phases, or both at which corresponding antennas 118 are to broadcast packets of the audio stream 115 so as to achieve a beamforming pattern that directs the broadcast packets toward one or more subscribed receiver devices 112.

In embodiments, beamforming model 195 includes one or more trained machine-learning models configured to receive broadcast subscriber link data 185 (e.g., one or more PERs, RSSIs) and broadcast subscriber AoA data 103 of one or more subscribed receiver devices 112 as inputs and provides one or more beamforming weights for one or more antennas 118 as outputs. As an example, beamforming model 195 includes one or more trained supervised models, unsupervised models, reinforcement models, neural networks (recurrent neural networks, convolutional neural networks), large language models, multimedia large language models, natural language models, deep-learning models, federated learning models, or any combination thereof configured to generate one or more beamforming weights for one or more antennas 118 from broadcast subscriber link data 185 and broadcast subscriber AoA data 103 according to a set of training data. Such training data, for example, includes sets of correlated data (e.g., sets of correlated beamforming weights, AoAs, certain subscriber link data, or a combination thereof), reward functions, sets of labeled data, sets of unlabeled data, validation data, test data, or any combination thereof. After beamforming model 195 generates one or more beamforming weights, tracking circuitry 106 is configured to update the antenna tuning profile 125 based on the generated beamforming weights. For example, tracking circuitry 106 updates the antenna tuning profile 125 such that one or more antennas 118 broadcast packets of the audio stream 115 in one or more directions as indicated by the generated beamforming weights. That is to say, tracking circuitry 106 updates the antenna tuning profile 125 such that one or more antennas 118 broadcast packets of the audio stream 115 in a beamforming pattern indicated by the beamforming weights. After the antenna tuning profile 125 is updated, broadcast circuitry 104 broadcasts one or more additional packets of the audio stream 115 based on the updated antenna tuning profile 125.

In embodiments, UE 102 includes a memory 108 that includes a storage, random-access memory (RAM) (e.g., static RAM, dynamic RAM), or both storing executable instructions, data, or both used by broadcast circuitry 104, tracking circuitry 106, or both to broadcast one or more audio streams 115, listen for one or more broadcast advertisement packets 155, update a broadcast subscriber list 175, determine broadcast subscriber link data 185, determine broadcast subscriber AoA data 103, update antenna tuning profile 125, or any combination thereof, to name a few. Further, in some embodiments, memory 108 stores executable instructions that, when executed by one or more processors 110 (e.g., central processing units, graphics processing units, microprocessors) of UE 102, cause the processors 110 to broadcast one or more audio streams 115, listen for one or more broadcast advertisement packets 155, update a broadcast subscriber list 175, determine broadcast subscriber link data 185, determine broadcast subscriber AoA data 103, update antenna tuning profile 125, or any combination thereof, to name a few. Additionally, one or more processors 110, in some embodiments, implement at least a portion of broadcast circuitry 104, tracking circuitry 106, or both.

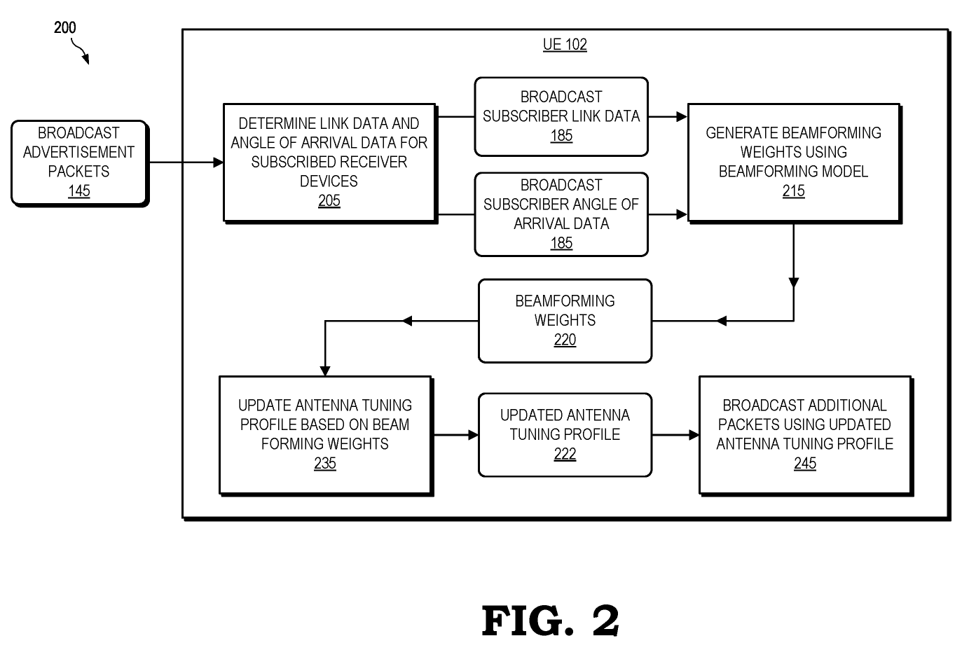

Referring now to FIG. 2, an example operation 200 for modifying an antenna tuning profile based on link quality data and angles of arrivals associated with receiver devices is presented, in accordance with embodiments. In embodiments, example operation 200 is implemented at least in part by tracking circuitry 106 of UE 102. Example operation 200 includes, at block 205, tracking circuitry 106 periodically listening for (e.g., every one second) and receiving broadcast advertisement packets 155 from one or more receiver devices 112 receiving at least a portion of broadcast audio stream 135. In response to receiving a broadcast advertisement packet 155, tracking circuitry 106 identifies the receiver device 112 indicated in the broadcast advertisement packet 155 (e.g., by a device ID) and adds data representing the receiver device 112 to the broadcast subscriber list 175. Additionally, tracking circuitry 106 determines broadcast subscriber AoA data 103 indicating the AoA at which the broadcast advertisement packet 155 was received and determines broadcast subscriber link data 185 (e.g., a PER, an RSSI, or both) based on the link status data 165 and transmit power indicated in the received broadcast advertisement packet 155. For example, to determine the broadcast subscriber link data 185 for a receiver device 112, tracking circuitry 106 identifies the PER indicated in the received broadcast advertisement packet 155 and determines an RSSI from the transmit power indicated in the received broadcast advertisement packet 155.

After generating broadcast subscriber link data 185 and broadcast subscriber AoA data 103 for one or more subscribed receiver devices 112 (e.g., receiver devices 112 added to the broadcast subscriber list 175), at block 215, tracking circuitry is configured to generate one or more beamforming weights 220 using beamforming model 195. For example, tracking circuitry 106 is configured to provide the broadcast subscriber link data (e.g., PER, RSSI, or both) and broadcast subscriber AoA data 103 of one or more subscribed receiver devices 112 as indicated by the corresponding most recently received broadcast advertisement packets 155 to beamforming model 195 as inputs. Beamforming model 195 then generates one or more beamforming weights 220 based on the provided broadcast subscriber link data (e.g., PER, RSSI, or both) and broadcast subscriber AoA data 103 and according to the training data associated with the beamforming model 195. As an example, beamforming model 195 generates beamforming weights 220 that achieve a beamforming pattern that improves the link quality between the UE 102 and one or more subscribed receiver devices 112. As another example, beamforming model 195 generates beamforming weights 220 that achieve a beamforming pattern that maximizes the link quality between the UE 102 and each subscribed receiver device 112. A beamforming weight 220, for example, indicates a weight for the amplitude, phase, or both at which one or more corresponding antennas 118 are to broadcast packets of the audio stream 115 so as to achieve a desired beamform pattern (e.g., such that the antennas 118 broadcast packets of the audio stream 115 in one or more desired directions).

At block 235, tracking circuitry 106 updates the antenna tuning profile 125 based on the beamforming weights 220 generated by the beamforming model 195 to produce an updated antenna tuning profile 222. For example, tracking circuitry 106 modifies one or more amplitudes, phases, or both indicated in the antenna tuning profile 125 at which antennas 118 are to broadcast packets according to the generated beamforming weights 220 to produce an updated antenna tuning profile 222. As another example, tracking circuitry 106 modifies the antenna tuning profile 125 so as to produce an updated antenna tuning profile 125 that achieves the beamforming pattern indicated by the generated beamforming weights 220. After tracking circuitry 106 produces the updated antenna tuning profile 222, at block 245, broadcast circuitry 104 is configured to broadcast one or more additional packets of the audio stream 115 based on the updated antenna tuning profile 222. For example, broadcast circuitry 104 broadcasts one or more additional packets of the audio stream in one or more directions as indicated by the updated antenna tuning profile 222.

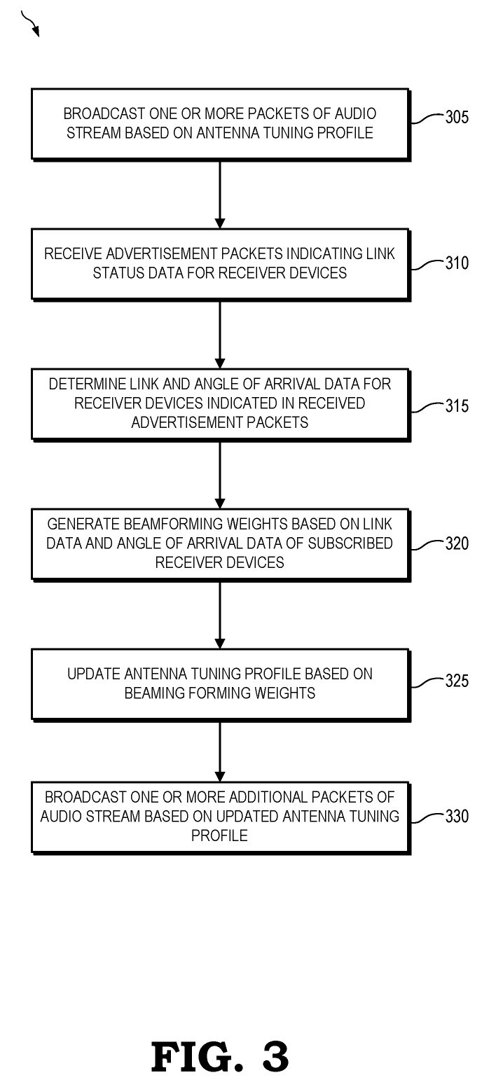

Referring now to FIG. 3, an example method 300 for adjusting an antenna tuning profile for a broadcast based on advertisement packets from one or more receiver devices is presented, in accordance with embodiments. In embodiments, example method 300 is implemented at least in part by UE 102. Example method 300 includes, at block 305, UE 102 broadcasting one or more packets of an audio stream 115 based on antenna tuning profile 125. For example, UE 102 broadcasts packets of audio stream 115 in one or more directions (e.g., in a beamforming pattern) based on the antenna tuning profile 125. In response to broadcasting one or more packets of audio stream 115, at block 310, UE 102 is configured to periodically listen for and receive one or more broadcast advertisement packets 155 including link status data 165 from one or more receiver devices 112 receiving at least a portion of the audio stream 115. At block 315, UE 102, in response to receiving a broadcast advertisement packet 155, adds data representing the receiver device 112 identified in the broadcast advertisement packet 155 (e.g., identified by a device ID in the broadcast advertisement packet 155) to the broadcast subscriber list 175. Additionally, in response to receiving a broadcast advertisement packet 155, UE 102 determines broadcast subscriber AoA data 103 indicating the angle at which the broadcast advertisement packet 155 was received and broadcast subscriber link data 185 representing, for example, a PER and RSSI of the receiver device 112 based on the link status data 165 and transmit power indicated in the broadcast advertisement packet 155.

At block 320, UE 102 is configured to generate one or more beamforming weights 220 based on the broadcast subscriber AoA data 103 and broadcast subscriber link data 185 of one or more receiver devices 112 identified in the broadcast subscriber list 175 (e.g., one or more subscribed receiver devices 112). For example, UE 102 implements beamforming model 195 configured to receive the broadcast subscriber AoA data 103 and broadcast subscriber link data 185 (e.g., PER, RSSI) of one or more subscribed receiver devices 112 as inputs and provide one or more beamforming weights 220 as outputs according to a set of training data. As an example, beamforming model 195, based on the broadcast subscriber AoA data 103 and broadcast subscriber link data 185 (e.g., PER, RSSI) of one or more subscribed receiver devices 112, generates one or more beamforming weights 220 that achieve a beamforming pattern that improves the link quality between UE 102 and one or more subscribed receiver devices 112. After generating these beamforming weights 220, at block 325, UE 102 is configured to update the antenna tuning profile 125 based on beamforming weights 220. For example, tracking circuitry 106 modifies one or more amplitudes, phases, or both indicated in the antenna tuning profile 125 at which antennas 118 are to broadcast packets according to the generated beamforming weights 220 to produce an updated antenna tuning profile 222. At block 330, UE 102 broadcasts one or more additional packets of the audio stream 115 based on the updated antenna tuning profile 222. As an example, UE broadcasts additional packets of the audio stream 115 in one or more directions so as to achieve a beamforming pattern indicated by the updated antenna tuning profile 222.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A user equipment (UE), comprising
broadcast circuitry including a plurality of antennas configured to broadcast at least a first packet of an audio stream in one or more directions based on an antenna tuning profile; and
tracking circuitry configured to:
receive a plurality of advertisement packets, each packet of the plurality of advertisement packets including link status data for a corresponding receiver device receiving the broadcast at least one first packet of the audio stream;
determine one or more beamforming weights based on the link status data and an angle of arrival of each advertisement packet of the plurality of advertisement packets; and
update the antenna tuning profile based on the beamforming weights to produce an updated antenna tuning profile,
wherein the plurality of antennas of the broadcast circuitry are configured to broadcast at least one additional packet of the audio stream in one or more directions based on the updated antenna tuning profile.

2. The UE of claim 1, wherein the broadcast circuitry is configured to:
broadcast the at least one first packet of the audio stream on one or more isochronous channels of the UE based on the antenna tuning profile; and
broadcast the at least one additional packet of the audio stream on the one or more isochronous channels of the UE based on the updated antenna tuning profile.

3. The UE of claim 1, wherein the tracking circuitry is configured to:
add data indicating each receiver device identified in the plurality of advertisement packets to a broadcast subscriber list.

4. The UE of claim 1, wherein the tracking circuitry is configured to:
for each receiver device identified in the plurality of advertisement packets, determine a packet error rate (PER) for the receiver device based on link status data included in the plurality of advertisement packets.

5. The UE of claim 4, wherein the tracking circuitry is configured to:
for each receiver device identified in the plurality of advertisement packets, determine a received signal strength indicator (RSSI) based on the plurality of advertisement packets.

6. The UE of claim 5, wherein the tracking circuitry is configured to:
implement a machine-learning model configured to receive the angles of arrival of the plurality of advertisement packets, PERs of receiver devices identified in the plurality of advertisement packets, and the RSSIs of the receiver devices identified in the plurality of advertisement packets as inputs and provide the one or more beamforming weights as an output.

7. The UE of claim 1, wherein the antenna tuning profile indicates one or more amplitudes and one or more phases at which the plurality of antennas are to broadcast the at least one first packet of the audio stream.

8. The UE of claim 1, wherein the one or more beamforming weights together indicate a beamforming pattern.

9. The UE of claim 1, wherein updated antenna tuning profile indicates a direction of one or more receiver devices identified in the plurality of advertisement packets.

10. The UE of claim 1, wherein the antenna tuning profile comprises an initial antenna tuning profile indicating one or more predetermined directions.

11. A user equipment (UE), comprising:
broadcast circuitry including a plurality of antennas configured to broadcast at least a first packet of an audio stream for one or more isochronous channels based on an antenna tuning profile; and
tracking circuitry configured to:
receive a plurality of advertisement packets, each packet of the plurality of advertisement packets including link status data for a corresponding receiver device receiving the broadcast at least one first packet of the audio stream;
for each receiver device identified in the plurality of advertisement packets:
determine an angle of arrival of an advertisement packet of the plurality of advertisement packets identifying the receiver device;
determine a packet error rate (PER) based on link status data indicated in the advertisement packet of the plurality of advertisement packets identifying the receiver device;
generate one or more beamforming weights based on the angles of arrival and PERs of the receiver devices identified in the plurality of advertisement packets; and
update the antenna tuning profile based on the one or more beamforming weights to produce an updated antenna tuning profile,
wherein the plurality of antennas of the broadcast circuitry is configured to broadcast at least one additional packet of the audio stream in one or more directions based on the updated antenna tuning profile.

12. The UE of claim 11, wherein the tracking circuitry is configured to implement a machine-learning model configured to receive the angles of arrival and PERs of the receiver devices identified in the plurality of advertisement packets as inputs and provide the one or more beamforming weights as an output.
